(19) United States
(12) Patent Application Publication
(10) Pub. No.: US 2026/0280772 A1
(43) Pub. Date: Sep. 17, 2026

(54) SYMBOL-LEVEL BASED DATA RETRANSMISSIONS

(71) Applicant: HUAWEI TECHNOLOGIES CO., LTD., Shenzhen (CN)

(72) Inventors: Miguel Angel GUTIERREZ ESTEVEZ, Munich (DE); Chan Zhou, Munich (DE)

(73) Assignee: HUAWEI TECHNOLOGIES CO., LTD., Shenzhen (CN)

(21) Appl. No.: 19/670,716

(22) Filed: May 7, 2026

Related U.S. Application Data
(63) Continuation of application No. PCT/EP2023/081523, filed on Nov. 10, 2023.

(51) Int. Cl. H04L 1/1812

(52) U.S. Cl. CPC H04L 1/1812

(57) ABSTRACT

A receiver entity and a transmitter entity are provided for the communication system. The receiver entity is configured to receive a message including one or more symbols from the transmitter entity, determine an average signal quality metric related to the one or more symbols, and send a retransmission request related to the one or more symbols to the transmitter entity if the average signal quality metric is below a predetermined threshold value. The transmitter entity is configured to send the message to the receiver entity, receive the retransmission request, and retransmit at least one of the one or more symbols to the receiver entity according to the retransmission request.

### CROSS-REFERENCE TO RELATED APPLICATION

This is a continuation of International Application No. PCT/EP2023/081523 filed on Nov. 10, 2023, the disclosure of which is hereby incorporated by reference in its entirety.

### TECHNICAL FIELD

Disclosed embodiments relate to a communication system and, in particular, to retransmissions of data in the communication system. The disclosure proposes a receiver entity and a transmitter entity for the communication system. These two entities are designed to implement symbol-level based retransmissions, for example, to implement a symbol-level based automatic repeat request (S-ARQ).

### BACKGROUND

Retransmissions of data are a critical part of modern communication systems. Data retransmissions can be implemented at multiple levels of the protocol stack, from the physical (PHY) layer in the form of a hybrid-automatic repeat request (HARQ), in the radio link control (RLC) layer as an automatic repeat request (ARQ), as well as in higher layers such as transmission control protocol/internet protocol (TCP/IP). The idea behind retransmitting data is, that if a data packet arrives with errors at the receiver entity, or is lost completely, a mechanism to recover that data packet is in place. Conventional retransmission mechanisms are either bit-level or packet-level based procedures, that is, they are implemented in the digital domain. However, these conventional retransmission mechanisms may not be suitable for all use cases and applications.

### SUMMARY

The present disclosure and its solutions are further based on the following considerations.

For several use cases and applications, symbol-level based retransmissions could be useful or may even be necessary. For example, for applications with extremely low latency requirements, a retransmission mechanism at the symbol level could allow detecting the necessity of retransmitting data, before performing demodulation, decoding, rate de-matching, de-interleaving, and cyclical redundancy check (CRC) on the data. This would reduce the round-trip delay. Another and more notorious use case for the implementation of symbol-level retransmissions would be in an integrated communication and computation (ICC)-compatible communication system.

ICC refers to specialized communication systems, in which the processing that is necessary to transmit data (e.g., coding and modulation of the data), and the processing that is necessary to generate application information (e.g., video, audio, or image compression performed on the data) is done in one single step. This is in stark contrast to conventional communication systems, in which the communication processing is independent from the application processing, and these types of processing are done in two independent steps.

FIG. 1 illustrates these differences between an ICC communication system 100 and a conventional communication system. Notably, the main variations of ICC communication systems 100 are joint source and channel coding (JSCC), semantic communications (SemCom), goal-oriented communications (GOCom), and over-the-air computation (OAC).

The benefits of the ICC systems 100 can vary greatly depending on the particular application and variation that is used, but in general great improvements in terms of efficiency are expected. For example, the number of communication and computation resources, which are necessary to achieve a certain performance, may be reduced. In addition, a higher robustness to channel aging and communication impairments may be achieved, when compared to conventional communication systems. The simplest form of the above-mentioned three variations JSCC, SemCOM, and GOCom of the ICC communication systems is point-to-point transmission, and represents the focus of this disclosure. OAC is relevant in multi-user environments, and is out of the scope of this disclosure.

Regardless of the rapid progress on the designs of ICC communication systems, the question how to deploy ICC systems as commercial systems, and how to integrate them with conventional communication systems remains an open problem, with very few and problematic proposed solutions.

The only option for data retransmissions in ICC systems is currently at the application level. However, this is inefficient both in terms of the amount of used communication resources and round-trip delay. These issues are illustrated in FIG. 2, which shows an exemplary procedure to request a retransmission at the application level in an ICC-compatible system. The waste of resources stems from the fact that a receiver entity (a base station (BS) in this case), which receives corrupted application data from a transmitter entity (a user equipment (UE) in this case), would unnecessarily forward the corrupted data to a server, since only the server is capable of detecting the corruption. The high latency stems from the fact that it takes a quite long time for the server to request retransmission and receive the retransmitted data from the UE.

In view of the above, this disclosure aims to provide a better solution for data retransmissions in a communication system, in particular, in an ICC communication system. An objective is to reduce a waste of resources compared to conventional solutions. Another objective is to reduce the round-trip delay and thus latency compared to conventional solutions. To this end, an objective is generally, how to implement symbol-level based retransmissions.

These and other objectives are achieved by the solutions of this disclosure as described herein and in the independent claims. Advantageous implementations are further described in the dependent claims.

A first aspect of this disclosure provides a receiver entity for a communication system, wherein the receiver entity is configured to: receive a message including one or more symbols from a transmitter entity; determine an average signal quality metric related to the one or more symbols; and send a retransmission request related to the one or more symbols to the transmitter entity, if the average signal quality metric is below a predetermined threshold value.

According to the first aspect, symbol-level based retransmissions may be implemented in the communication system, which may be an ICC system. Since the receiver entity can request a retransmission on the symbol level, the amount of wasted resources compared to conventional solutions can be reduced. In particular, because the receiver entity does not have to send corrupted data to a server. Consequently, also a reduction of the round-trip delay and thus the latency of data retransmission in the communication system can be achieved.

A symbol may represent data to be transmitted from the transmitter entity to the receiver entity. A symbol may consist of one or more data bits, as determined by a modulation format used in the communication system. For example, in a binary phase shift keying (BPSK) based communication system, each symbol may represent 1 bit. In a quadrature phase shift keying (QPSK) based communication system, each symbol may represent 2 bits.

In an implementation form of the first aspect, the retransmission request includes an indication that at least one of the one or more symbols has to be retransmitted by the transmitter entity to the receiver entity.

For instance, only a subset of the symbols of the message may be requested for retransmission, wherein the subset of the symbols may be selected according to lowest quality metrics.

In an implementation form of the first aspect, the receiver entity is configured to combine the one or more symbols of the message with one or more previously transmitted symbols, and to determine the average signal quality metric based on the combination of the symbols.

In this way, the reliability of correct reception of the data represented by the symbols may be achieved, and the waste of resources reduced.

In an implementation form of the first aspect, the receiver entity is configured to determine the average signal quality metric based on at least one of a noise level and a channel coefficient of a channel between the transmitter entity and the receiver entity.

Thus, channel conditions may be taken into account.

In an implementation form of the first aspect, the receiver entity is further configured to send an acknowledgement (ACK) message to the transmitter entity, if the average signal quality metric is equal to or above the predetermined threshold value, wherein the ACK message indicates that the one or more symbols were correctly received at the receiver entity.

In an implementation form of the first aspect, the acknowledgement message comprises a 1-bit acknowledgement indication.

In an implementation form of the first aspect, the retransmission request is a not-acknowledgement (NACK) message or is included in a NACK message.

In an implementation form of the first aspect, the receiver entity is further configured to forward the message to an application server entity, if the average signal quality metric is equal to or above the predetermined threshold value.

Thus, corrupted data is not forwarded to the server entity. As explained above, this reduces the waste of resources and the round-trip delay.

In an implementation form of the first aspect, the average signal quality metric is a signal to noise ratio (SNR) or is a signal to interference plus noise ratio (SINR), or a channel quality indicator (CQI), or any other metric representing the quality of the received signal.

In an implementation form of the first aspect, the receiver entity is for an ICC system, and the one or more symbols of the message include ICC application data of an application entity of the ICC system.

The receiver entity of the first aspect is thus suitable for implementing a new mechanism for retransmissions—at the symbol level—into ICC systems and ICC-compatible systems.

In an implementation form of the first aspect, the receiver entity is a data plane entity.

A second aspect of this disclosure provides a transmitter entity for a communication system, wherein the transmitter entity is configured to: send a message including one or more symbols to a receiver entity; receive a retransmission request related to the one or more symbols from the receiver entity; and retransmit at least one of the one or more symbols to the receiver entity according to the retransmission request.

According to the second aspect, symbol-level based retransmissions may be implemented in the communication system, which may be an ICC system. Since the transmitter entity can perform a retransmission on the symbol level, the amount of wasted resources compared to conventional solutions can be reduced at the receiver entity. In particular, because the receiver entity does not have to send corrupted data to a server or to a UE. Similar advantages are generally achieved as by the receiver entity of the first aspect.

In an implementation form of the second aspect, the retransmission request includes an indication that the at least one of the one or more symbols has to be retransmitted by the transmitter entity to the receiver entity.

In an implementation form of the second aspect, the retransmission request further includes an indication that at least one of one or more previous symbols also has to be retransmitted by the transmitter entity to the receiver entity, and the transmitter entity is further configured to retransmit the at least one of the one or more previous symbols to the receiver entity according to the retransmission request.

In an implementation form of the second aspect, the transmitter entity is configured to buffer at least the one or more symbols of the message until receiving the retransmission request or an ACK message from the receiver entity, the ACK message indicating that the one or more symbols were correctly received by the receiver entity.

In an implementation form of the second aspect, the transmitter entity is an application entity for the ICC system.

A third aspect of this disclosure provides a method for a receiver entity of a communication system, wherein the method comprises: receiving a message including one or more symbols from a transmitter entity; determining an average signal quality metric related to the one or more symbols; and sending a retransmission request related to the one or more symbols to the transmitter entity, if the average signal quality metric is below a predetermined threshold value.

In an implementation form of the third aspect, the retransmission request includes an indication that at least one of the one or more symbols has to be retransmitted by the transmitter entity to the receiver entity.

In an implementation form of the third aspect, the method comprises combining the one or more symbols of the message with one or more previously transmitted symbols, and determining the average signal quality metric based on the combination of the symbols.

In an implementation form of the third aspect, the method comprises determining the average signal quality metric based on at least one of a noise level and a channel coefficient of a channel between the transmitter entity and the receiver entity.

In an implementation form of the third aspect, the method further comprises sending an ACK message to the transmitter entity, if the average signal quality metric is equal to or above the predetermined threshold value, wherein the ACK message indicates that the one or more symbols were correctly received at the receiver entity.

In an implementation form of the third aspect, the acknowledgement message comprises a 1-bit acknowledgement indication.

In an implementation form of the third aspect, the retransmission request is a NACK message or is included in a NACK, message.

In an implementation form of the third aspect, the method further comprises forwarding the message to an application server entity, if the average signal quality metric is equal to or above the predetermined threshold value.

In an implementation form of the third aspect, the average signal quality metric is a SNR or is a SINR.

In an implementation form of the third aspect, the receiver entity is for an ICC system, and the one or more symbols of the message include ICC application data of an application entity of the ICC system.

In an implementation form of the third aspect, the receiver entity is a data plane entity.

The method of the third aspect and its implementation forms achieve the same advantages as the receiver entity of the first aspect and its corresponding implementation forms.

A fourth aspect of this disclosure provides a method for a transmitter entity of a communication system, wherein the method comprises: sending a message including one or more symbols to a receiver entity; receiving a retransmission request related to the one or more symbols from the receiver entity; and retransmitting at least one of the one or more symbols to the receiver entity according to the retransmission request.

In an implementation form of the second aspect, the retransmission request includes an indication that the at least one of the one or more symbols has to be retransmitted by the transmitter entity to the receiver entity.

In an implementation form of the fourth aspect, the retransmission request further includes an indication that at least one of one or more previous symbols also has to be retransmitted by the transmitter entity to the receiver entity, and the transmitter entity is further configured to retransmit the at least one of the one or more previous symbols to the receiver entity according to the retransmission request.

In an implementation form of the fourth aspect, the method comprises buffering at least the one or more symbols of the message until receiving the retransmission request or an ACK message from the receiver entity, the ACK message indicating that the one or more symbols were correctly received by the receiver entity.

In an implementation form of the fourth aspect, the transmitter entity is an application entity for the ICC system.

The method of the fourth aspect and its implementation forms achieve the same advantages as the transmitter entity of the second aspect and its corresponding implementation forms.

A fifth aspect of this disclosure provides a computer program comprising instructions which, when the program is executed by a processor of a receiver entity or a transmitter entity, respectively, cause the receiver entity or transmitter entity to perform the method according to the third aspect or fourth aspect or any implementation form thereof.

A sixth aspect of this disclosure provides a non-transitory storage medium storing executable program code which, when executed by a processor, causes the method according to the third aspect or fourth aspect or any implementation form thereof to be performed.

It has to be noted that all entities, elements, units and means described in this specification can be implemented by software or hardware elements or any kind of combination thereof. All steps performed by the various entities described herein, as well as the functionalities described to be performed by the various entities, are intended to mean that the respective entity is adapted to or configured to perform the respective steps and functionalities. Even if, in the following description of specific embodiments, a specific functionality or step to be performed by external entities is not reflected in the description of a specific detailed element of that entity, which performs that specific step or functionality, it should be clear for a skilled person that these methods and functionalities can be implemented by respective software or hardware elements, or any kind of combination thereof.

### BRIEF DESCRIPTION OF DRAWINGS

The above-described aspects and implementations are explained in the following description in relation to the accompanying drawings, in which:

FIG. 1 shows a comparison between a conventional communication system (left side) and an ICC communication system (right side).

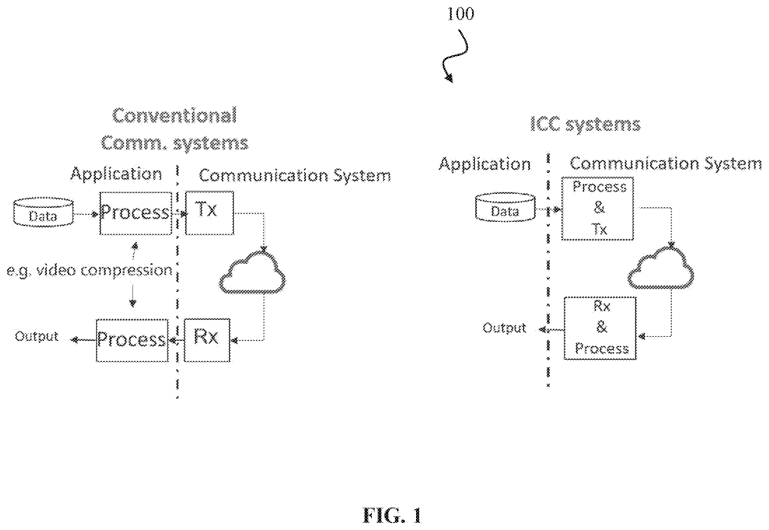

FIG. 2 shows a conventional procedure to request a data retransmission at the application level, wherein the high latency and waste of resources of the conventional procedure are highlighted.

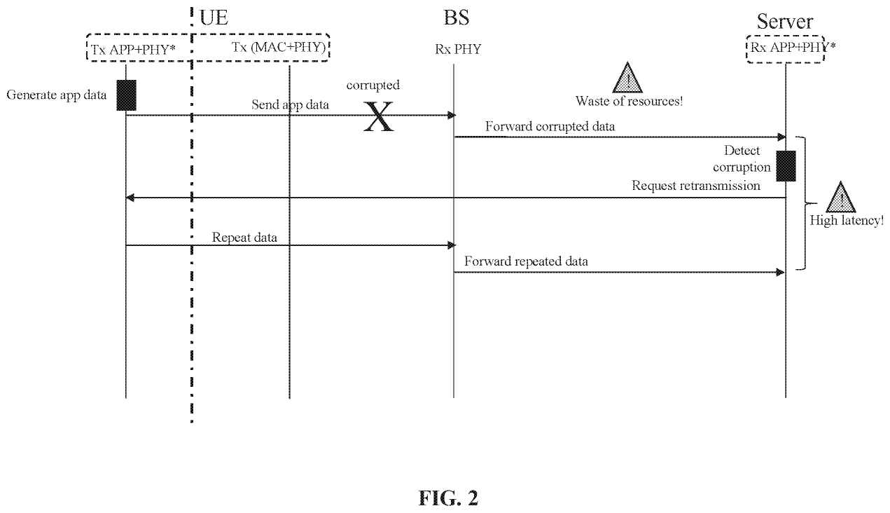

FIG. 3 shows a transmitter entity and a receiver entity according to this disclosure.

FIG. 4 shows an aspect of this disclosure for implementing symbol-level based re-transmissions.

FIG. 5 shows an exemplary procedure and message exchange between a transmitter entity and a receiver entity according to this disclosure.

FIG. 6 shows details of an exemplary S-ARQ procedure at a receiver entity according to this disclosure.

FIG. 7 shows details of an exemplary S-ARQ procedure at a transmitter entity according to this disclosure.

FIG. 8 shows exemplary inputs to and outputs from an exemplary RC function of a receiver entity according to this disclosure.

FIG. 9 illustrates an integration of an exemplary S-ARQ procedure into an ICC-compatible communication system.

FIG. 10 shows an example of an RC function after MMSE equalization at a receiver entity according to this disclosure.

FIG. 11 shows a method for a receiver entity according to this disclosure.

FIG. 12 shows a method for a transmitter entity according to this disclosure.

### DETAILED DESCRIPTION OF EMBODIMENTS

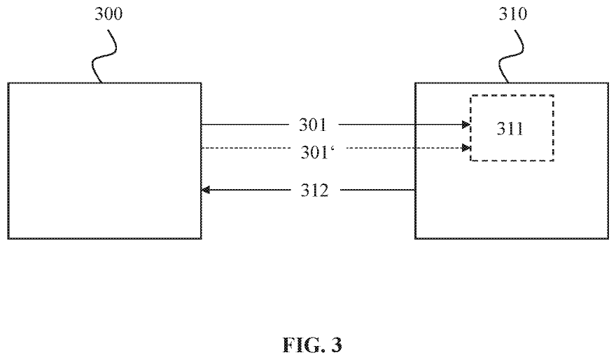

FIG. 3 shows a transmitter entity 300 and a receiver entity 310 according to this disclosure. The transmitter entity 300 and the receiver entity 310 may be part of a wireless communication system such as an integrated communication and computation (ICC) system or an ICC-compatible system. The communication system may be a 3GGP-compliant mobile communication system. The transmitter entity 300 may, as an example, be a UE, for instance, may be a mobile device, a smartphone, a computer, a robot or machine, or a vehicle. The receiver entity 310 may, as an example, be a network device like a base station, a gNodeB, a transmit and receive point (TRP), or a similar unit. Disclosed embodiments may relate to an uplink scenario and uplink transmissions. However, the solutions of the present disclosure can also apply to downlink transmissions, wherein e.g., a base station transmits information from a server or the like to a UE. In this downlink scenario, the transmitter entity 300 may be a network device like a base station, a gNodeB, a TRP, or a similar unit, and the receiver entity 310 may be a UE.

The transmitter entity 300 is configured to send a message 301 to the receiver entity 310, wherein the message 300 includes one or more symbols which may represent data to be conveyed. To this end, the transmitter entity 300 may comprise one or more antennas, and may comprise one or more transmitter chains connected to the one or more antennas. The transmitter entity 300 may perform one or more transmitter-related processing steps on data that is then represented by the symbols.

The receiver entity 310 is configured to receive the message 301 including the one or more symbols from the transmitter entity 310. To this end, the receiver entity 310 may comprise one or more antennas, and may comprise one or more receiver chains connected to the one or more antennas. The receiver entity 300 may perform one or more receiver-related processing steps on the message 301 including the symbols.

The receiver entity 310 is further configured to determine an average signal quality metric 311 related to the one or more symbols. For instance, the average signal quality metric may be a SNR or SINR of the symbols. The determination of the quality metric 311 may be performed by a processor, or the like, of the receiver entity 310.

The receiver entity 310 is further configured to send a retransmission request 312 related to the one or more symbols to the transmitter entity 300, if the average signal quality metric 311 is below a predetermined threshold value. Otherwise, it may send no retransmission request 312. In particular, the retransmission request 312 may indicate that at least one of the one or more symbols of the message 301 has to be retransmitted by the transmitter entity 300 to the receiver entity 310.

The transmitter entity 300 is configured to receive the retransmission request 312 related to the one or more symbols from the receiver entity 310. The transmitter entity 300 is then further configured to retransmit at least one of the one or more symbols to the receiver entity 310 according to the (indication in the) retransmission request 312, for instance, in a further message 301′ including one or more retransmitted symbols.

The transmitter entity 300 and/or the receiver entity 310 may respectively comprise a processor (not shown, already mentioned above for the receiver entity 310) or processing circuitry configured to perform, conduct or initiate various operations of the respective entity 300, 310 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The transmitter entity 300 and/or the receiver entity 310 may respectively further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective entity 300, 310 to be performed. In one embodiment, the processing circuitry comprises one or more processors and a non-transitory memory connected to the one or more processors. The non-transitory memory may carry executable program code which, when executed by the one or more processors, causes the respective entity 300, 310 to perform, conduct or initiate the operations or methods described herein.

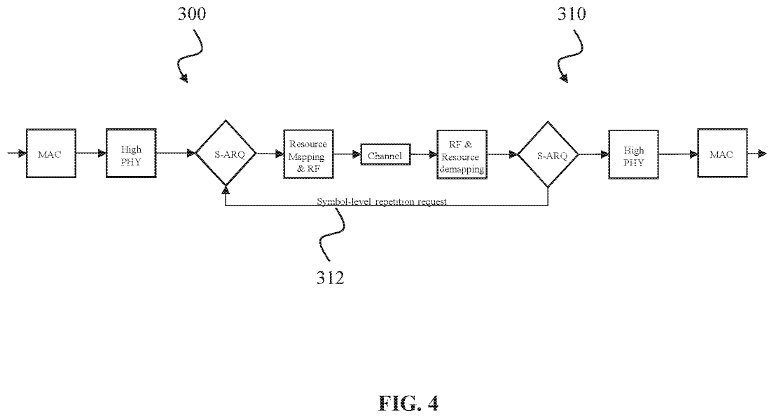

FIG. 4 shows an aspect of this disclosure for implementing symbol-level based retransmissions, in particular, an S-ARQ procedure. FIG. 4 shows functional blocks of a transmitter entity 300 and a receiver entity 310 according to this disclosure, which may be based on the entities 300, 310 described above with respect to FIG. 3. Same elements are labelled with the same reference signs and may be implemented in an identical manner.

The depicted aspect is a mechanism at the PHY layer, which enables retransmissions of I/Q symbols (i.e., the one or more symbols mentioned above). A pair of new functions is provided at the transmitter entity 300 and the receiver entity 310, respectively, wherein the new functions enable the implementation of the S-ARQ procedure. These functions are thus referred to as S-ARQ functions or blocks with respect to FIG. 4. In general terms, the S-ARQ function at the receiver entity 310 checks, if the received symbols of the message 301 matches the required quality metric 311, e.g. a SNR, in order to allow for a proper detection and decoding of the one or more symbols of the message 301. If this is not the case, i.e., if the quality metric 311 is below the threshold value, the S-ARQ function at the receiver entity 310 sends the request 312 for retransmission of at least one of the one or more symbols to the transmitter entity 300. Meanwhile, the receiver entity 310 may keep the symbols of the message 301 of the first transmission in a buffer, for example, for a later combination with the posterior retransmissions. As shown in FIG. 4, the S-ARQ functions are located between a High PHY block and a resource (de-)mapping and RF block at respectively the transmitter entity 300 and the receiver entity 310.

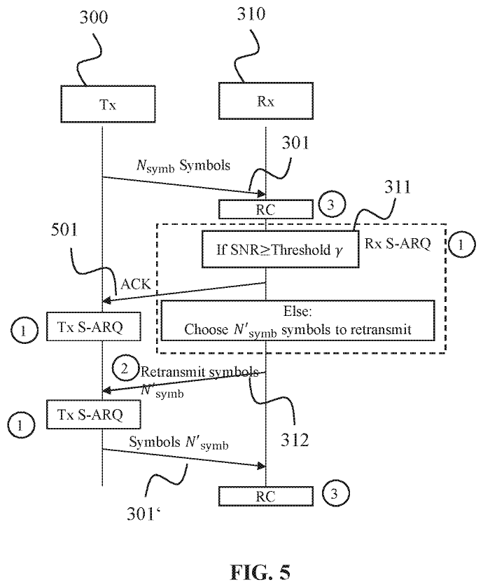

FIG. 5 shows an exemplary procedure and message exchange between a transmitter entity 300 and a receiver entity 310 according to this disclosure.

The present disclosure may implement at least three features, namely, (i) new functions to handle retransmissions at the symbol level at the transmitter entity 300 and the receiver entity 310 (e.g., the S-ARQ functions shown in FIG. 4), (ii) a new control message, i.e., the retransmission request 312, also considered containing S-ARQ information, between the receiver entity 310 and the transmitter entity 300 (particularly, between the receiver entity S-ARQ function and the transmitter entity S-ARQ function), and (iii) a further new function at the receiver entity 310 for combining all symbol-level (re-)transmissions, which is also referred to as retransmissions combining (RC). The exemplary procedure of FIG. 5 is as follows:
1. The transmitter entity 300 sends a transport block (TB) with N_{symb} number of symbols (i.e., the message 301) to the receiver entity 310, wherein N_{symb} is an integer equal to or larger than 1. The transmitter entity 300 may buffer the one or more symbols of the message 301, for example, until receiving an ACK.
2. The receiver entity 310 combines the received one or more symbols with previously transmitted symbols in the RC function, in cases where previous transmissions exist. Otherwise the RC function just passes the information to the S-ARQ function of the receiver entity 310.
3. The S-ARQ function of the receiver entity 310 then checks if the quality metric 311, for example, the average SNR of the received one or more symbols, is greater or equal to the predefined threshold value γ. If this condition is held, the S-ARQ function of the receiver entity 310 sends an ACK message 501 to the S-ARQ function of the transmitter entity 300, wherein the ACK message 501 confirms that the reception of the message 301 was correct. Otherwise, the S-ARQ function of the receiver entity 310 chooses N′_{symb} symbols that need to be retransmitted, and sends this S-ARQ information in the retransmission request 312 to the S-ARQ function of the transmitter entity 300. This information may also serve as a NACK. In case of a 1-bit acknowledgment, N′_{symb}=N_{symb} and there is no selection needed. Alternatively, N′_{symb} can be selected as, e.g., the N′_{symb} symbols with the lowest quality metric 311, wherein N′_{symb}≤N_{symb}, and this information is communicated to the S-ARQ function of the transmitter entity 300. The benefit of the latter way is that the size of the symbol retransmissions can be reduced, however, at the expense of a higher feedback. The sending of the ACK 501 or NACK 312, as explained above, may be compatible with standard procedures for sending ACKs and NACKs, such as an implicit or explicit communication of the ACK or NACK, a synchronous or asynchronous mechanism, a flexible timing between data transmission, a codebook-based ACK or NACK, or an ACK or NACK timing in slot configuration.
4. Upon reception of the retransmission request 312, the S-ARQ function of the transmitter entity 300 retransmit the N′_{symb} symbols to the receiver entity 310, for instance, in a further message 301′.
5. The RC function at the receiver entity 310 then combines the received retransmitted symbols with the previously buffered symbols, and passes an output to the S-ARQ function of the receiver entity 310, which may be based thereon perform step 3 again.

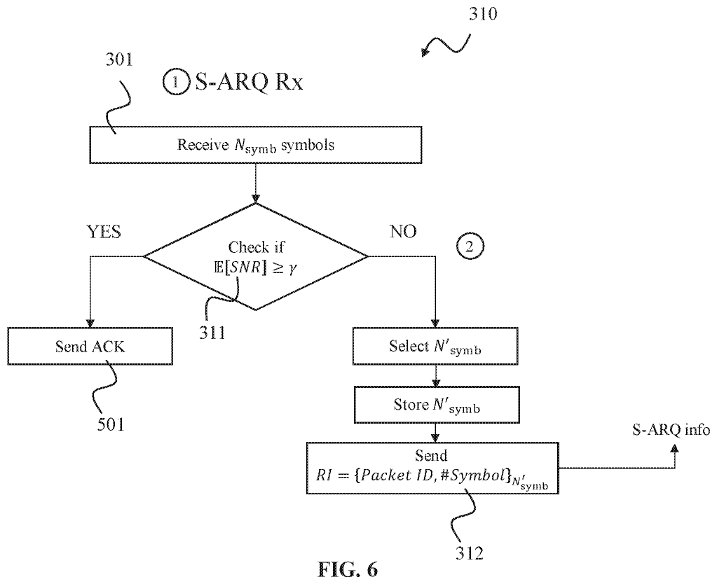

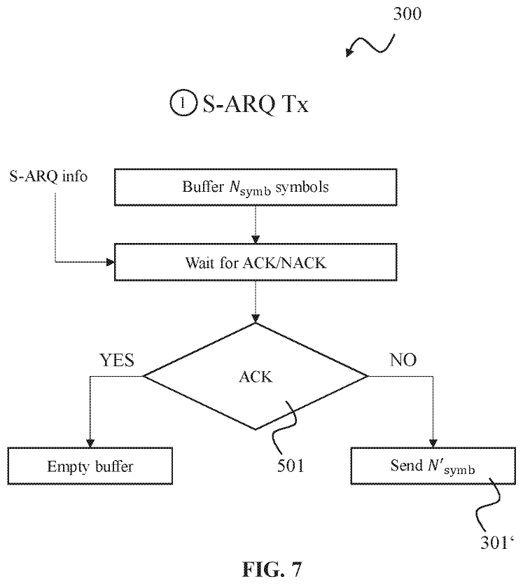

The FIGS. 6 and 7 zoom into the procedure at the S-ARQ function of respectively the receiver entity 310 and the transmitter entity 300, as described above. In particular, FIG. 6 shows details of the S-ARQ procedure (or function) at the receiver entity 310, and FIG. 7 shows details of the S-ARQ procedure (or function) at the transmitter entity 300. It can be seen that the S-ARQ information (in the retransmission request 312) may comprises, for each symbol of the N′_{symb} symbols, a packet ID and a symbol number.

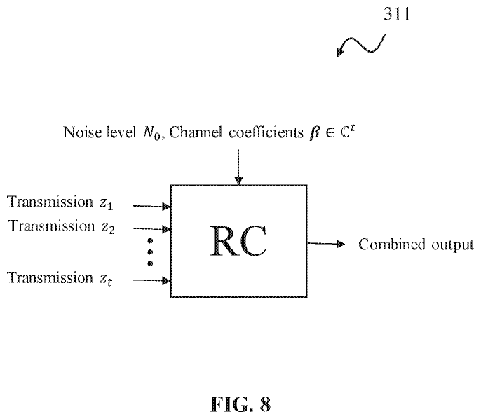

FIG. 8 shows exemplary inputs to an RC function of the receiver entity 310, and an output from the RC function of the receiver entity 310. In particular, FIG. 8 shows the input-to-output mapping of the RC function. The RC function may receive, as one input, all received symbols z₁, z₂, . . . , zₜ of all (re-)transmissions 1, 2 . . . t, and may further receive, as additional inputs, channel and noise information β, N₀ regarding the channel between the transmitter entity 300 and the receiver entity 310. The RC may provide, as output, the combination of all the transmissions.

In the following, a few exemplary embodiments based on the above described transmitter entity 300, receiver entity 310, and particularly the symbol-level based retransmission procedure (e.g., S-ARQ) are described.

A first exemplary embodiment relates to the transmission of S-ARQ-related control information in 3^{rd} generation partnership project (3GPP) communication systems. Two options may be used for the control information of the S-ARQ, for example, depending on if the procedure is synchronous or asynchronous.

For the asynchronous transmission—and similar to feedback related to HARQ in 5^{th} generation new radio (5G-NR)—the S-ARQ feedback information can be provided as a part of the downlink control information (DCI) of the physical downlink control channel (PDCCH), for instance, using formats Format_0_0 or Format_0_1 for the configuration of S-ARQ in the uplink, and/or using formats Format_1_0 or Format_1_1 for downlink configuration. This is described similarly in 3GPP TS 38.212, clause 7.3.1 and the sub-clauses therein. Note that in this case N′_{symb}=N_{symb}, as the receiver entity 310 does not explicitly notify the transmitter entity 300 about the necessity of a retransmission, which can be automatically detected at the transmitter entity 300 when a certain timer expires. Note that for compatibly with the HARQ process, the maximum timer multiplied by number of retransmissions of the S-ARQ procedure is preferably smaller than the timer for an HARQ retransmission.

For the synchronous transmission, the receiver entity 310 preferably notifies the number N′_{symb} of symbols that need to be retransmitted. In the case of uplink transmission, this information can be included again in the DCI message of the PDCCH. For the downlink transmission, this information can be included in the uplink control information (UCI) of the physical uplink control channel (PUCCH).

The configuration of the type of transmission (e.g., synchronous or asynchronous) and the number of parallel S-ARQ procedures can be included in the radio resource control (RRC) protocol.

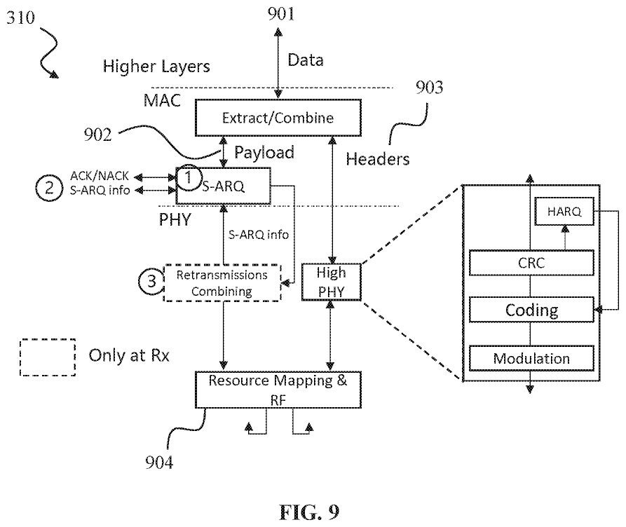

A second exemplary embodiment relates to support for ICC applications. The S-ARQ can be especially useful, because HARQ is not supported, and retransmissions can conventionally only happen at the application layer otherwise, as is the case of ICC applications, as explained in the background section. In this case, the S-ARQ function can be integrated in an ICC-compatible communication system, for example, as shown in FIG. 9.

FIG. 9 shows that a pair of functions may be provide in the data plane of the medium access (MAC) layer at the receiver entity 310, called “extract” and “combine”. The job of the extract function is to extract payload 902 (ICC application data 902) of ICC applications from headers 903 of certain data messages 901 so that the payload 902 can be transported directly to a resource mapping & RF function 904 of the PHY layer. Meanwhile, the headers 903 are sent through a standard path, wherein standard PHY layer functions are applied to the headers 903, since the headers represent unstructured data and need to be encoded, modulated and so on. To implement this extract function, the receiver entity 310 may be configured to separate, at the MAC layer, the ICC application data 902 from the headers 903 of the messages 901, and further to send the ICC application data 902 directly to the resource mapping & RF function 904. Further, the combine function collects the received payload information (ICC application data 902) and the headers 903 and combines them into packets 901 to be delivered at higher layers. To implement this combine function, receiver entity 310 may be configured to combine, at the MAC layer, the ICC application data 902 with the headers 903.

The S-ARQ function may be inserted in the path of the ICC application data 902 to the resource mapping & RF function 904, as shown. In this case, the quality metric 311 (here the SNR) threshold γ for retransmission may be application-dependent, and may be provided by an ICC scheduler, which is aware of this parameter per application.

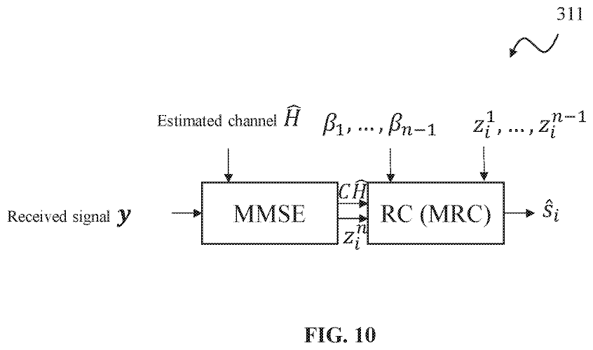

A third exemplary embodiment relates to the RC function. FIG. 10 shows an exemplary input-output relation of the RC function, assuming that the channel equalization is done with minimum mean squared error (MMSE). One option to implement the RC function is using the maximum ratio combining (MRC) approach over all transmissions z₁, z₂, . . . , zₜ. Given the channel model

$$z = β {s}_{i} + n ,$$

wherein β=[β₁, β₂, . . . , βₜ]^{T} is the vector containing the channel experienced by each retransmission of the symbol sᵢ and multiplied by the channel equalization matrix, and n is the noise vector, the MRC that estimates ŝᵢ is given by:

$$( ∀ i ∈ 1 , … , {N}_{s y m b} ) {\hat{s}}_{i} = arg {min}_{s} {‖ {z}_{i} - {β}_{i} s ‖}^{2} = {( {β}_{i}^{*} {β}_{i} )}^{- 1} {β}_{i}^{*} {z}_{i}$$

Assuming the MMSE equalizer, z=Cy with C=Ĥ*(ĤĤ*+N₀I)⁻¹, y=Hsᵢ+n, H is the channel frequency response and Ĥ is the estimated channel.

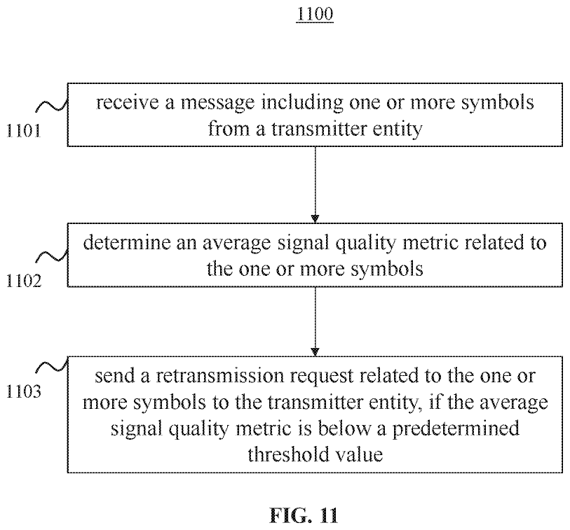

FIG. 11 shows a flow-diagram of a method 1100, which may be performed by a receiver entity 310 according to this disclosure. The method 1100 comprises a step 1101 of receiving a message 301 including one or more symbols from a transmitter entity 300. The method 1100 further comprises a step 1102 of determining an average signal quality metric 311 related to the one or more symbols. The method 1100 also comprises a step 1103 of sending a retransmission request 312 related to the one or more symbols to the transmitter entity 300, if the average signal quality metric 311 is below a predetermined threshold value.

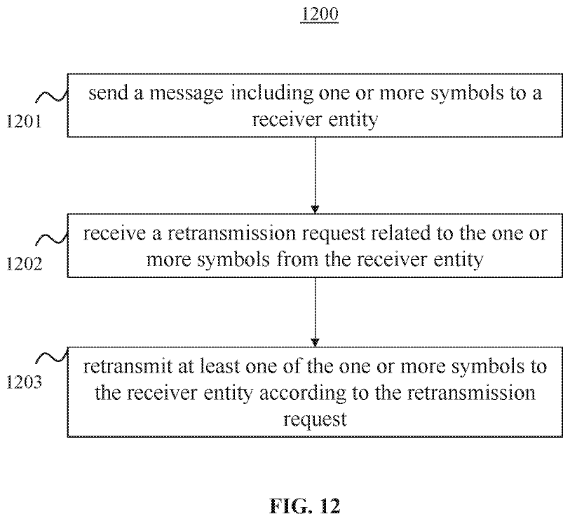

FIG. 12 shows a flow-diagram of a method 1200 which may be performed by a transmitter entity 300 according to this disclosure. The method 1200 comprises a step 1201 of sending a message 301 including one or more symbols to a receiver entity 310. Further, the method 1200 comprises a step 1202 of receiving a retransmission request 312 related to the one or more symbols from the receiver entity 310. The method 1200 also comprises a step 1203 of retransmitting at least one of the one or more symbols in a further message 301′ to the receiver entity 310, according to the retransmission request 312.

In summary of this disclosure, the enablement of retransmissions at the symbol level reduces the round-trip delay, since e.g., demodulation, rate-de-matching, deinterleaving, and decoding processes are not needed before deciding that a retransmission is necessary. Further, the symbol-level based procedure enables data retransmissions in communication systems without HARQ or ARQ mechanisms, such as ICC or ICC-compatible communication systems.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A method for a receiver entity, comprising:
receiving, from a transmitter entity, a message including one or more symbols;
determining an average signal quality metric related to the one or more symbols; and
sending, to the transmitter entity, a retransmission request related to the one or more symbols, if the average signal quality metric is below a predetermined threshold value.

2. The method of claim 1, wherein the retransmission request includes an indication that at least one of the one or more symbols has to be retransmitted by the transmitter entity to the receiver entity.

3. The method of claim 1, further comprising:
combining the one or more symbols of the message with one or more previously transmitted symbols; and
determining, based on the combination of the symbols, the average signal quality metric.

4. The method of claim 1, further comprising:
determining, based on at least one of a noise level and a channel coefficient of a channel between the transmitter entity and the receiver entity, the average signal quality metric.

5. The method of claim 1, further comprising:
sending, to the transmitter entity, an acknowledgement (ACK) message if the average signal quality metric is equal to or above the predetermined threshold value, wherein the ACK message indicates that the one or more symbols were correctly received at the receiver entity.

6. The method of claim 1, further comprising:
generating the retransmission request related to the one or more symbols.

7. The method of claim 1, wherein the retransmission request is a not-acknowledgement (NACK) message or is included in a NACK message.

8. The method of claim 1, further comprising:
forwarding, to an application server entity, the message if the average signal quality metric is equal to or above the predetermined threshold value.

9. A receiver entity, comprising:
at least one processor, and at least one memory storing instructions that, when executed by the at least one processor, cause the receiver entity to:
receive, from a transmitter entity, a message including one or more symbols;
determine an average signal quality metric related to the one or more symbols; and
send, to the transmitter entity, a retransmission request related to the one or more symbols, if the average signal quality metric is below a predetermined threshold value.

10. The receiver entity of claim 9, wherein the retransmission request includes an indication that at least one of the one or more symbols has to be retransmitted by the transmitter entity to the receiver entity.

11. The receiver entity of claim 9, wherein execution of the instructions by the at least one processor further causes the receiver entity to:
combine the one or more symbols of the message with one or more previously transmitted symbols; and
determine, based on the combination of the symbols, the average signal quality metric.

12. The receiver entity of claim 9, wherein execution of the instructions by the at least one processor further causes the receiver entity to:
determine, based on at least one of a noise level and a channel coefficient of a channel between the transmitter entity and the receiver entity, the average signal quality metric.

13. The receiver entity of claim 9, wherein execution of the instructions by the at least one processor further causes the receiver entity to:
send, to the transmitter entity, an acknowledgement (ACK) message if the average signal quality metric is equal to or above the predetermined threshold value, wherein the ACK message indicates that the one or more symbols were correctly received at the receiver entity.

14. The receiver entity of claim 9, wherein execution of the instructions by the at least one processor further causes the receiver entity to:
generate the retransmission request related to the one or more symbols.

15. The receiver entity of claim 9, wherein the retransmission request is a not-acknowledgement (NACK) message or is included in a NACK message.

16. The receiver entity of claim 9, wherein execution of the instructions by the at least one processor further causes the receiver entity to:
forward, to an application server entity, the message if the average signal quality metric is equal to or above the predetermined threshold value.

17. A transmitter entity, comprising:
at least one processor, and at least one memory storing instructions that, when executed by the at least one processor, cause the transmitter entity to:
send, to a receiver entity, a message including one or more symbols;
receive, from the receiver entity, a retransmission request related to the one or more symbols; and
retransmit, to the receiver entity, at least one of the one or more symbols in response to the retransmission request.

18. The transmitter entity of claim 17, wherein the retransmission request includes an indication that the at least one of the one or more symbols has to be retransmitted by the transmitter entity to the receiver entity.

19. The transmitter entity of claim 17, wherein the retransmission request further includes an indication that at least one of one or more previous symbols also has to be retransmitted by the transmitter entity to the receiver entity, wherein execution of the instructions by the at least one processor further causes the transmitter entity to:
retransmit, to the receiver entity, the at least one of the one or more previous symbols in response to the retransmission request.

20. The transmitter entity of claim 17, wherein execution of the instructions by the at least one processor further causes the transmitter entity to:
buffer at least the one or more symbols of the message until receiving the retransmission request or an acknowledgement (ACK) message from the receiver entity, wherein the ACK message indicates that the one or more symbols were correctly received by the receiver entity.
